(19) United States
(12) Patent Application Publication
(10) Pub. No.: US 2014/0366439 A1
(43) Pub. Date: Dec. 18, 2014

(54) APPARATUSES, SYSTEMS AND METHODS FOR ENHANCING PLANT GROWTH

(71) Applicant: Solartrack, LLC, New York, NY (US)

(72) Inventors: Martin Ben-Dayan, New York, NY (US); William D. Bickmore, Saint George, UT (US)

(21) Appl. No.: 14/303,882

(22) Filed: Jun. 13, 2014

Related U.S. Application Data
(60) Provisional application No. 61/835,239, filed on Jun. 14, 2013.

(51) Int. Cl. A01G 7/04; G02B 5/24; F21V 9/12; F21V 9/10; G02B 5/22

(52) U.S. Cl. CPC A01G 7/045; F21V 9/10; G02B 5/22; F21V 9/12; G02B 5/24; F21W 2131/109
USPC 47/58.1 LS; 362/351; 359/885; 362/145

(57) ABSTRACT

Nanoparticles (NPs) may be used to transform the energy of harmful or less useful wavelengths into beneficial and more useful wavelengths of light for a multitude of purposes including, for example, promotion of photosynthesis, enhancing germination timing, enhancing bloom timing. In one embodiment, a greenhouse structure may include nanoparticles embedded in a glass or plastic panel, or may include nanoparticles disposed on a surface of such a panel, to alter the wavelength of available light to a desired wavelength in order to alter an event associated with plant life contained within the greenhouse structure. In another embodiment, nanoparticles may be applied directly to a part of a plant structure (e.g., leaves, stems, etc.) to alter a characteristic of light before receipt of the light by the plant.

### CROSS-REFERENCE TO RELATED APPLICATIONS

This application claims the benefit of U.S. Provisional Patent Application No. 61/835,239, filed Jun. 14, 2013 and entitled ENHANCING LIGHT SPECTRA TO BENEFIT CULTIVATION OF COMPLEX AND MONO-CELLULAR PLANT LIFE THROUGH THE USE OF NANOPARTICLES, the disclosure of which is incorporated by reference herein in its entirety.

### BACKGROUND

Both sun light and artificial light are used by plants to provide energy for photosynthesis by means of chlorophyll pigment. Some wavelengths of light are preferred by various mono-cellular and complex cellular plants. The solar spectrum contains 4% of its energy in the ultraviolet region, 52% in the infrared region and 44% as visible light. The useable spectrum for plants to capture energy lies almost entirely in the visible part of the spectrum. Ultraviolet and infrared wave lengths are mostly damaging to plant life. Ultraviolet light can cause photo chemical damage and disrupt plant DNA. Infrared wavelengths may cause damage by overheating the plant.

Chlorophyll is the pigment used by plants to perform photosynthesis. It is contained in chloroplasts within the plant's cellular structure, for example, near the surface of the plants leaf, needle, or stem structures. It is readily exposed to sunlight in mono-cellular plant life. There are two main types of chlorophyll; Type A and Type B. Other pigments, such as carotenoids, may also assist in photosynthesis. As shown in the graph of FIG. 1, during photosynthesis, different types of plant pigments exhibit different absorption rates as various wavelengths of the solar spectrum. For example, Chlorophyll A exhibits a peak absorption rate at a wavelength that is approximately 430 nanometers (nm), while Chlorophyll B exhibits a peak absorption rate at a wavelength that is approximately 470 nm. FIG. 2 provides a representation of a typical profile of wavelengths that are useful in photosynthesis. The values are presented as a percentage of maximal values. Thus, for example, light at a wavelength of approximately 400 nm to approximately 500 nm, particularly at a wavelength of approximately 440 nm, may be seen as being effective in the photosynthesis process. As a reference, FIG. 3 shows the spectrum of the sun as seen at noon at sea level. The Y-axis indicates the relative luminosity for various wavelengths shown along the X-axis.

Excessive light at wavelengths higher than 750 nanometers (nm) and lower than 350 nm may cause damage to the plant. Land plants generally appear green because the chloroplast is reflecting the green light that is not useful to the plant. Deep water, on the other hand, will cause the energy in lower wavelengths of blue and green to be greatly diminished. The red light sensing chlorophyll is most useful to the underwater plant growing at depths where the blues and greens are greatly attenuated. The sun produces the highest amount of energy at about 518 nm, which is green in color. However, while an entire symphony of wavelengths is available, many are not useful for a given plant for photosynthesis or other purposes.

The amount of light received, combined with the type of light being received, by a plant has an impact on a variety of events during the photosynthesis process. For example, the germination and the bloom time of a plant may be effected by how much light is received, and what type of light is received by the plant. Additionally, the general health and robustness of a plant is impacted not only by the quantity of light, but the quality of light (which may differ from plant to plant) received by a given plant. The duration of these events (e.g., germination and bloom time) is also impacted by the light being received.

Commercial growers are not only interested in rapid healthy growth of their stock but they may also desire to more closely control germination and/or bloom times, and other aspects of the plant life cycle which may be light-wavelength dependent.

### BRIEF SUMMARY OF THE INVENTION

In accordance with the present invention, nanoparticles may be used to alter a characteristic of light in order to manipulate the photosynthesis process in plant life. In accordance with one embodiment, a method of altering plant growth is provided, wherein the method includes disposing a plurality of nanoparticles (NPs) between a light source and a plant component, interacting light from the light source with the plurality of NPs and altering a characteristic of the light, and transmitting the altered light to the plant.

In one embodiment, altering a characteristic of the light includes shifting the light from a first wavelength to a second wavelength.

In one embodiment, disposing a plurality of NPs between a light source and a plant component further comprises applying the NPs to a surface of the plant component. In one particular embodiment, applying the NPs to a surface of the plant component includes dispersing the NPs in a liquid solution and applying the liquid solution on the plant component.

In one embodiment, the method may further include applying the NPs to a surface of a structure associated with the light source.

In one embodiment, disposing a plurality of NPs between a light source and a plant component further includes embedding the NPs in a plastic or glass material and disposing the plastic or glass material between the light source and the plant component.

In one embodiment, disposing a plurality of NPs between a light source and a plant component further includes embedding the NPs in a polymer film and disposing the polymer film between the light source and the plant component.

In one embodiment, disposing a plurality of NPs between a light source and a plant component further comprises disposing the NPs on a surface of a substantially transparent or translucent structure.

In one embodiment, disposing a plurality of NPs between a light source and a plant component includes forming a greenhouse structure, the greenhouse structure comprising the plurality of NPs.

In one embodiment, the NPs are disposed within a material wherein the thickness of the material is approximately twice the diameter of the largest NPs disposed within the material or greater. In one particular embodiment, the thickness of the material is at least about 150 nm and about 300 nm.

In one embodiment, the plant component includes a seed, wherein the method further comprises altering the germination time of the plant seed responsive to the altered light.

In one embodiment, the method further includes altering the bloom time of the plant component responsive to the altered light.

In one embodiment, the method further includes disposing the NPs in a liquid solution.

In one embodiment, the plurality of NPs includes at least two differently sized NPs.

In one embodiment, the plurality of NPs includes at least two differently shaped NPs.

In one embodiment, the method further includes suspending the plurality of NPs in a biologically inert, optically clear adhesive material. In one particular embodiment, the method includes applying the adhesive material directly to the plant component.

In one embodiment, the plant component includes algae. In one embodiment, the method further includes subsequently forming a synthetic fuel from the plant component.

In one embodiment, shifting the wavelength of light transmitted from the light source through the NPs further includes shifting the light to a wavelength to inhibit plant growth.

In accordance with another aspect of the invention, a structure configured to alter plant growth is provided. The structure includes at least one substantially optically transparent component, a plurality of nanoparticles (NPs) associated with the at least one component, wherein the plurality of NPs are configured to alter a light wave from a first wavelength to a second wavelength in order to alter the growth cycle of a plant.

In accordance with one embodiment, the at least one component includes a panel in a greenhouse structure.

In one embodiment, the at least one component includes a retractable light shade.

In one embodiment, the at least one component is configured to cover at least a portion of a row of plants in a crop field.

In one embodiment, the plurality of NPs are embedded in the at least one component.

In one embodiment, the plurality of NPs are coated on a surface of the at least one component.

In one embodiment, the plurality of NPs include at least two differently sized NPs.

In one embodiment, the plurality of NPs include at least two differently shaped NPs.

Features and aspects described in accordance with one embodiment described herein may be combined with features and aspects of other described embodiments without limitation.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a graph showing the sensitivities of certain plant pigments to various wavelengths of light;

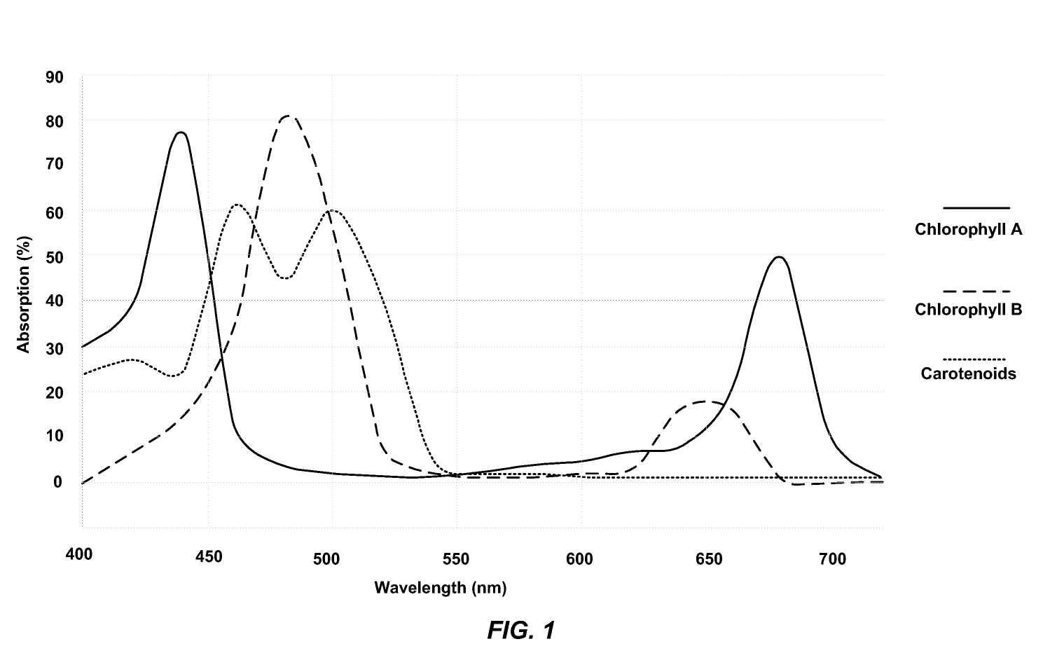

FIG. 2 is graph showing a profile of the effectiveness of various wavelengths in the photosynthesis process;

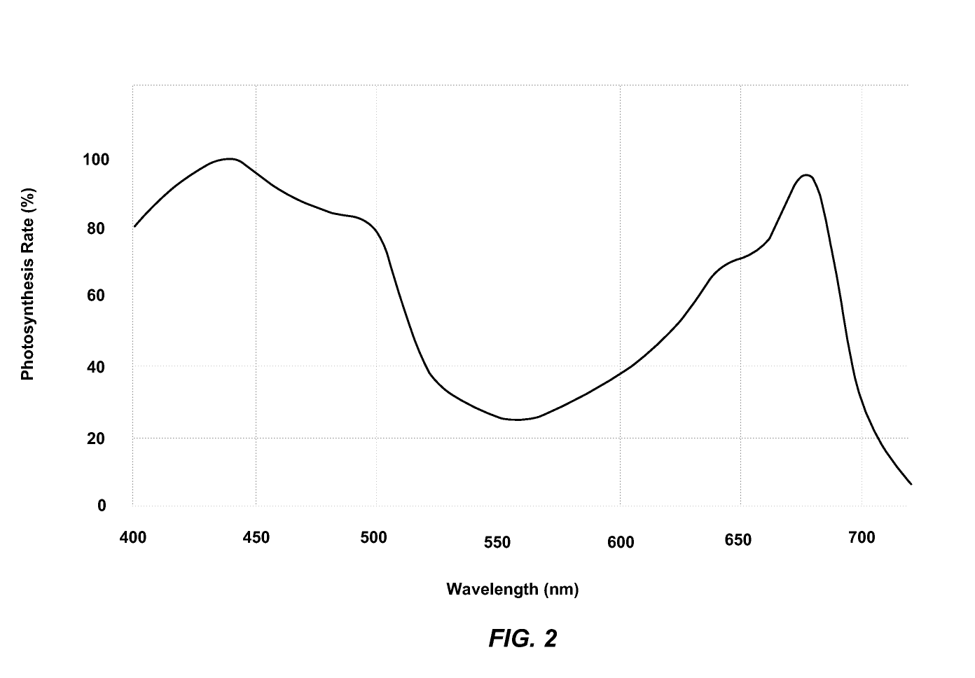

FIG. 3 is a graph depicting the solar spectrum at sea level;

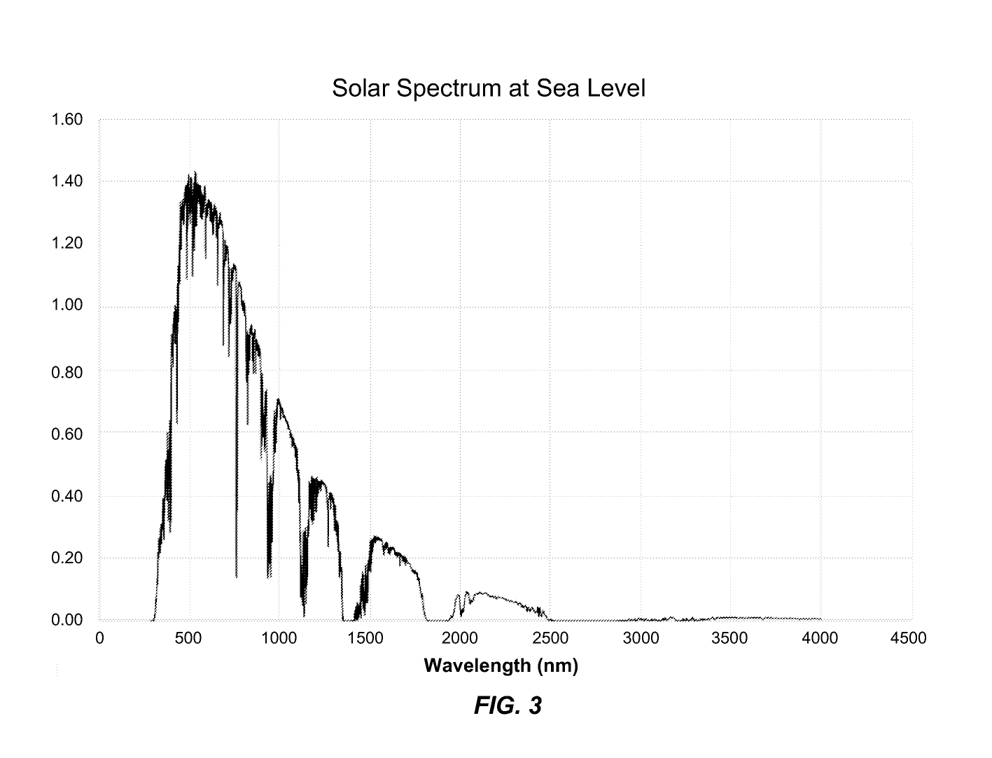

FIG. 4-12 are cross-sectional views of various nanoparticles and composite nanoparticles according to embodiments of the invention;

FIG. 13 shows a greenhouse structure according to an embodiment of the present invention;

FIGS. 14A-C show cross sections of a panel of a greenhouse structure according to various embodiments;

FIG. 15 is a schematic view of a process for making a material component that may be used in conjunction with a greenhouse or other structure according to an embodiment of the invention;

FIG. 16 shows a portion of a greenhouse structure according to another embodiment of the invention;

FIG. 17 shows a light fixture in accordance with an embodiment of the invention;

FIG. 18 is a cross-sectional view of a component of the light fixture shown in FIG. 17;

FIG. 19 shows a light fixture in accordance with another embodiment of the invention;

FIGS. 20 and 21 show a plants having a coating in accordance with an embodiment of the invention;

FIG. 22 shows a tent or structure placed between plants and a light source according to an embodiment of the invention;

FIG. 23 is a graph showing the spectral output of a specified light in accordance with a described example;

FIG. 24 is a bar chart showing the improvement in light output of a described example in comparison to a non-modified light; and

FIG. 25 is a graph showing the enhancement of solar light through the use of NPs.

### DETAILED DESCRIPTION OF THE INVENTION

Nanoparticles (NPs) can be designed to cause spectral energy shifts in either direction. Shifts towards the red or infrared part of the spectrum are commonly called redshifts. Shifts toward the shorter wavelengths are called blue shifts. For example, various examples of using NPs to enhance the collection of solar energy are described in U.S. patent application Ser. No. 14/137,603 entitled APPARATUS, SYSTEMS AND METHODS FOR COLLECTING AND CONVERTING SOLAR ENERGY, filed Dec. 20, 2013, the disclosure of which is incorporated by reference herein in its entirety.

The present invention contemplates the use of NPs or “quantum dots” to shift the energy levels within the spectrum of light, whether of solar or artificial origin, to improve the desired biological performance of plant life. The energy levels of various wavelengths of light are manipulated such that undesirable wavelengths are attenuated and desirable wavelengths are amplified. In some embodiments, the NPs may be wholly or in part metallic and capable of forming a plasmon quasi body about which electrons are thought to freely circulate and operate to effectuate a reduction of the energy levels in one part of the spectrum and an amplification of another part of the spectrum. The light may be manipulated in a manner to alter the balance of energy of various wavelengths within the spectrum of light, such that it controls, or has significant influence over, events of the plant life cycle. Such events may be made longer or shorter in duration, depending upon the desired outcome of plant cultivators. NPs or quantum dots may be used to manipulate the spectrum of available light to improve photosynthesis of mono-cellular and/or poly-cellular plant life and may therefore promote more rapid plant growth, and or plant robustness. In one embodiment, plant growth may either be accelerated or retarded, for example, to target specific delivery dates.

In one embodiment, the NPs may be used to manipulate the spectrum of available light to improve germination time of plant seeds and may therefore result in less rapid or more rapid germination times as desired for market timing and other considerations.

In another embodiment, the NPs may be used to manipulate the spectrum of available light to hasten or lesson bloom time in plants and may therefore result in less rapid or more rapid bloom time as desired for market timing and other considerations.

In certain embodiments, the NPs may be disposed within a fluid carrier at a preferred concentration, the fluid having a desired index of refraction. The fluid may be disposed in a container having the ability to transmit light at desired wavelengths. In some examples, the container may be formed of a material such as polycarbonate, polystyrene, polyethylene terephthalate (PET), polyurethane, acrylic, or some other generally optically transparent material.

In embodiments where the NPs are suspended in a polymer liquid, the NPs may be dispersed within the liquid at a desired density or concentration in order to effect the manipulation of the desired wavelengths of light. In some embodiments, the liquid may be solidified through any of a variety of known methods, including, for example, exothermic chemical reaction, endothermic chemical reaction, catalytic induced chemical reaction, evaporation of a volatile chemical component, a reaction accelerated by ultraviolet light or other wavelengths of light, exposure to atmospheric gases or any other source causing a state change from liquid to solid and holding said NPs in a desired configuration which may include a fixed three dimensional matrix.

In some embodiments, NPs of different sizes, different shapes, and/or construct (e.g., materials, compositions) may be used simultaneously (or, in other words, they may concurrently exist within a common carrier medium) to manipulate the energy of a variety of wavelengths across large sections of the spectrum not otherwise conveniently controlled by a single type of NP.

In one embodiment, NPs may be suspended in biologically inert optically clear adhesives and then attached directly to a portion of the plant (e.g., the leaf and stem surfaces). The adhesive may be configure to adhere to the plant regardless of exposure to water or other elements, while not significantly interfering with plant growth or respiration. Non limiting examples of such an adhesive include Orco Adhesive 309 Hi Conc and Orco RTS Flower Spray, available from Organic Dyestuffs Corporation having a place of business at 65 Valley Street, East Providence, R.I. 02914.

In some embodiments, the NPs may be attached to an optically transparent substrate such as glass or polymer as a coating, such as by spreading or spraying a self-hardening clear liquid compound which contains the NPs. In yet other embodiments, the NPs may be embedded in a film (e.g., a polymer film) or a glass or plastic substrate. It is noted that plastic materials that are used in various embodiments of the invention may include a thermoplastic or a thermoset material, such as organic polymers to which plasticizers have been added.

In one embodiment, NPs may be embedded into, or applied to a surface of, a thermally insulated optically clear film or a bubble wrap-type material that is designed to prevent plants from being damaged by frost or other environmental hazards.

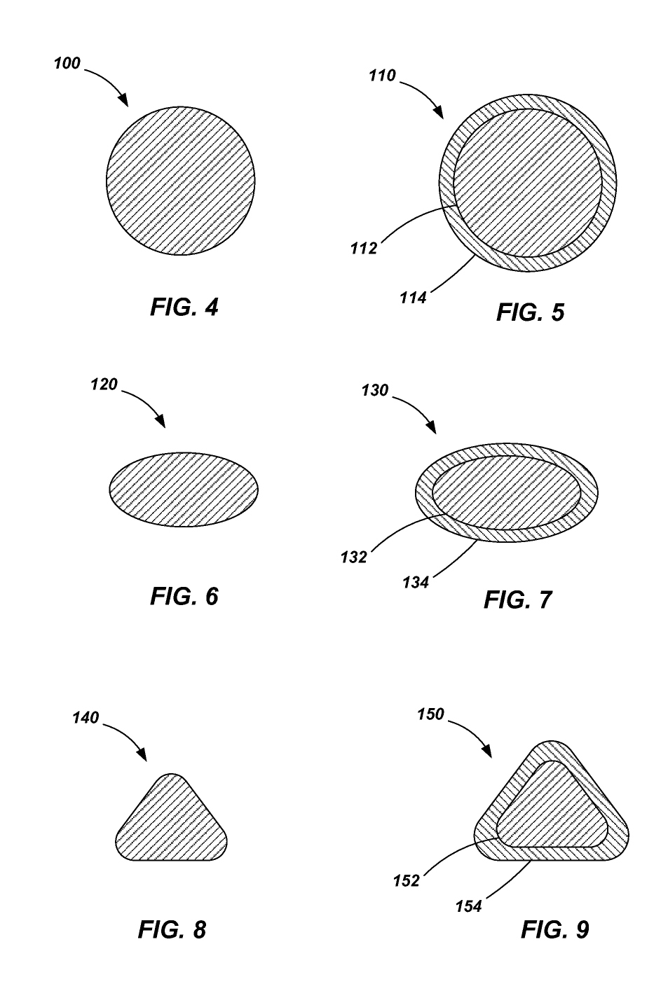

NPs may be designed and produced in a number of ways to effectuate wavelength shifts which may be advantageous for a particular plant or a group of related plants. Spherical NPs will follow Mei's theoretical calculations which relate such variables as size of the kernel, often made of relatively larger metallic material (e.g., gold or silver that is approximately 90 nm or 100 nm in diameter), which may be combined with shells silica or other generally transparent material that is approximately 5 nm to 20 nm thick. The NP may be made in any of a variety of shapes and range in size, for example, from 4 nm up to 200nm, or greater, in the largest dimension. Additionally, the NPs may be modified in various ways, such as by the addition of a spectral shifting dye. For example, in one embodiment, an outer shell of a NP may be “stained” with a fluorescent dye such as rhodamine. The dye will cause a spectral of a specific narrow spectrum of light to a higher, or longer, wavelength. FIGS. 4-12, described below, show several types of non-limiting, wavelength shifting NPs that are contemplated for use in various embodiments of the present invention.

FIG. 4 shows a cross section of a substantially spherical metallic NP 100 (e.g., gold, silver, copper). The NP 100 may exhibit a diameter of, for example, approximately 10 nm to approximately 250 nm. It is noted that the terms “approximately” and “substantially” are used herein are to indicate that the values may be within industry accepted tolerances rather than being absolute. Referring to FIG. 5, a cross-sectional view of a substantially spherical composite NP 110 is shown. The NP 110 includes a substantially spherical metal core 112 with a coating 114 of a substantially transparent material such as silica. Again, the metal core 112 may exhibit a diameter of approximately 10 nm to approximately 250 nm in accordance with one embodiment, while the transparent coating may exhibit a thickness of approximately 5 nm to approximately 20 nm. The coating may serve a number of purposes. For example, the coating may serve to functionalize the NP to be compatible with the material in which it is suspended. It may also be used as a transparent optical path in tightly packed NPs. Additionally, it may be used as a material to absorb fluorescent dyes used to cause a wavelength shift. Further, it may serve as a dielectric. The NP 110 shown in FIG. 5, being formed of multiple materials, may be referred to as a composite NP. In another embodiment, the composite NP may be configured to have a non-metallic core (e.g., silica) and a thin coating of a metallic material disposed around the core. Composite NPs may be obtained commercially from providers such as nanoComposix of San Diego, Calif.

FIG. 6 shows a cross section of a substantially ellipsoidal metallic NP 120. In one example, the dimension along the major axis of the NP 120 may be between approximately 20 nm and approximately 250 nm while the dimension along the minor axis may be approximately 100 nm or less. Referring to FIG. 7, a substantially ellipsoidal composite NP 130 is shown. The NP 130 includes a metallic core 132 and a substantially transparent coating 134 of a material such as silica. The metal core 132 may exhibit a dimension along the major axis of between approximately 20 nm and approximately 250 nm and a dimension along the minor axis of approximately 100 nm or less. The coating may exhibit a thickness of approximately 5 nm to approximately 20 nm. In another embodiment, the construction may be reversed with core being formed of a non-metallic material (e.g., silica) and the shell or coating comprising a thin metallic layer of metallic material.

FIG. 8 shows a cross section of a metallic NP 140 formed as a substantially triangular platelet. In one example, the NP 140 may exhibit a height (measured along a line that is perpendicular to the base and extending from base to the apex) that is between approximately 100 nm and approximately 200 nm with a thickness (i.e., measured in a direction that is perpendicular to the plane of the drawing figure) of between approximately 10 nm and approximately 40 nm. FIG. 9 shows a cross section of a composite NP 150 formed as a substantially triangular platelet. The composite NP 150 includes a substantially metallic core 152 exhibiting a substantially triangular platelet geometry, and a substantial transparent material coating 154 of a material such as silica. In one embodiment, the core may be configured substantially similarly to the NP 140 shown in FIG. 8, and the coating may exhibit a thickness of approximately 5 nm to approximately 20 nm. In another embodiment, the construction may be reversed with the core being formed of a non-metallic material (e.g., silica) and the shell or coating comprising a thin metallic layer of metallic material.

Referring to FIG. 10, a cross-sectional view is shown of a composite NP 160 with a metallic core 162 and a coating of a substantially transparent material 164 such as silica. The NP may exhibit a variety of geometries including substantially spherical or ellipsoidal geometries. A spectral shifting dye 166 (e.g., a fluorescent dye) is embedded in, coated on, or otherwise mixed with, the transparent material 164. The dye 166 may assist in shifting the wavelength to longer wavelengths (“red shifting”) or shorter wavelengths (“blue shifting”) to help align the wavelength of the available light to the sensitivity of an associated PV cell. For example, the dye may include any of the dyes listed in TABLE 1 below, although other dyes may also be used.

TABLE 1

| | EXCITATION λ | EMISSION λ |
|---|---|---|
| FLUORESCENT DYE | (nm) | (nm) |
| Abberior Star | 437 | 515 |
| Alexa Fluor 405 | 401 | 421 |
| Alexa Fluor 430 | 434 | 541 |
| Alexa Fluor 610X | 612 | 628 |
| Alexa Fluor 700 | 702 | 723 |
| Cyanine Cy3 | 550 | 570 |
| Cyanine Cy5 | 650 | 670 |
| DyLight 550 | 562 | 576 |
| DyLight 650 | 654 | 673 |
| DyLight 750 | 754 | 776 |
| Fluorescein | 494 | 521 |
| Rhodamine B | 540 | 625 |
| Rhodamine 6G | 526 | 555 |
| Rhodamine 123 | 511 | 534 |
| Texas Red | 596 | 615 |

Referring to FIGS. 11 and 12, perspective views are shown of NPs configured as a nano-cone 170 and a nano-rod 180. The nano-cones 170 and nano-rods 180 are formed of a substantially transparent material such as silica. A spectral shifting dye 182 may be coated on, embedded in, or otherwise mixed with, the transparent material. The shapes of the nano-cones 170 and nano-rods 180 may additional assist in shifting the angle of incidence of the light impinging upon a PV cell in order to bring the angle of incidence closer to perpendicular with the light collecting surface of a PV cell, making it more suitable for power generation by the PC cell.

The NPs depicted in FIGS. 4-12 are representative of various types of NPs that may be used in accordance with embodiments of the present invention. Additionally, as noted above, a single type of NP need not be used exclusive of other types of NPs. Rather, multiple types of NPs may be used together in various combinations.

Prior to disposal in some other medium, the NPs may undergo a process of functionalization to provide the NPs with certain desirable characteristics. For example, the NPs may be functionalized to enable a desired distribution pattern of the NPs within a selected carrier medium (e.g., when embedded within in a polymer, such as polyurethane). Functionalization may include tailoring the surface coating of NPs in order to regulate stability, solubility, and targeting. A coating that is multivalent or polymeric confers high stability. When certain distribution patterns of the NPs within a carrier medium are desired, it can be important to properly functionalize the NPs prior to being dispensed within the media. Improperly prepared NPs may agglomerate into large clusters, or may exhibit a streaking or other non-uniform distribution patterns, and otherwise inhibit optimal spacing between the NPs within the suspending substrate or other carrier media. The functionalizing coating is desirably immune to solvents used in the carrier media (e.g., liquid polymer, such as xylene, toluene, or methanol prior to it solidifying by release of aromatic gases or catalytic reaction).

The NPs may be used in a variety of different embodiments to alter a characteristic of artificial or natural life in order to tailor the photosynthesis process of plant life such as described below. For example, it may be desirable to increase or enhance the photosynthesis process where sunlight is inadequate due to climatic conditions and/or sun light obstructions.

Various embodiments of the invention may be used to increase or enhance photosynthesis and consequential plant growth or plant fruiting, where artificial light is used for photosynthesis and power consumption reduction is desired. Artificial lighting can be made to better address the needs of the plant while simultaneously not producing as much energy at wavelengths which are harmful or not beneficial to the plant.

Blooming in plants may be governed by the mix of solar or artificial light wavelengths. As the suns spectrum varies seasonally, some plants use the spectral shifts to cue blooming. NPs may be used to alter the timing of a natural blooming event in plants, either extending the amount of time or reducing it on a desired outcome. Similarly, NPs may be used to spectrally manipulate light in order to extend or reduce the time associated with germination or some other event in a plant's life cycle.

Additionally, NPs may be used to impede the growth of an undesirable plant variety or species while encouraging the growth of (or at least not impeding the growth of) another plant variety or species where differing requirements for light exist among varieties or species of plants which occupy the same growing space, and one variety or species is considered undesirable (e.g., a “weed”).

NPs may be used to provide better spectra and more economical delivery of photon energy to enhance production of algae for use in synthetic fuels or food. Such may be accomplished in association with either solar or artificial illumination. It is noted that electrical energy is a major cost in indoor algae synthetic fuel production. U.S. Patent Application Publication No. 20110229775 to Michaels et al., published on Sep. 22, 2011, which is incorporated by reference herein, in its entirety, discloses examples of the production of algae and the conversion of algae for, among other things, fuel.

Researchers tasked in the creation of on-board production of edible food on a space craft must optimize every part of the process due to weight and energy restrictions. In various embodiments of the invention, NPs may be used in conjunction with the limited energy resources for plant food production in association with space travel.

Additionally, NPs may be used to effect the photosynthesis process of plant life in order to reduce atmospheric CO₂— or CO₂ within a closed environment such as in an interplanetary space craft, space station, underwater living quarters, or closed quarters bio-domes—through the optimization of plant growth and, consequently, the optimization of the fixing of CO2.

As described in more detail below, NPs may be used in conjunction with the production of greenhouse panels, windows, window covers, artificial lights or light covers in order to manipulate solar and artificial light for commercial growers.

NPs may be used in association with plant growth to modify plant physiology through light wavelength modification, to alter or manipulate the strength and quality of woods, to encourage dwarfism, to improve stem sturdiness, to improve fruit quality, to control the size and robustness of blossom, and to control or manipulate any other plant physiological changes which are economically or scientifically desirable.

In short, NPs may be used to alter plant growth in association with any and all uses where it is desirable to manipulate the balance of energies associated with the various wavelengths of light during the plant life cycle.

While the following embodiments and methods of delivery for NP wave shifting technologies are given as examples, the invention is not be limited to these embodiments. In all embodiments the index of refraction of the associated carrier material should be harmonious with the NP and desired wave shift. NPs may be embedded in various solid and liquid media or attached as a coating or via adhesives to various surfaces. Various optically clear or translucent thermoplastics, catalyst activated epoxies, polymers in coatings, flexible web film, or solid glass may be used.

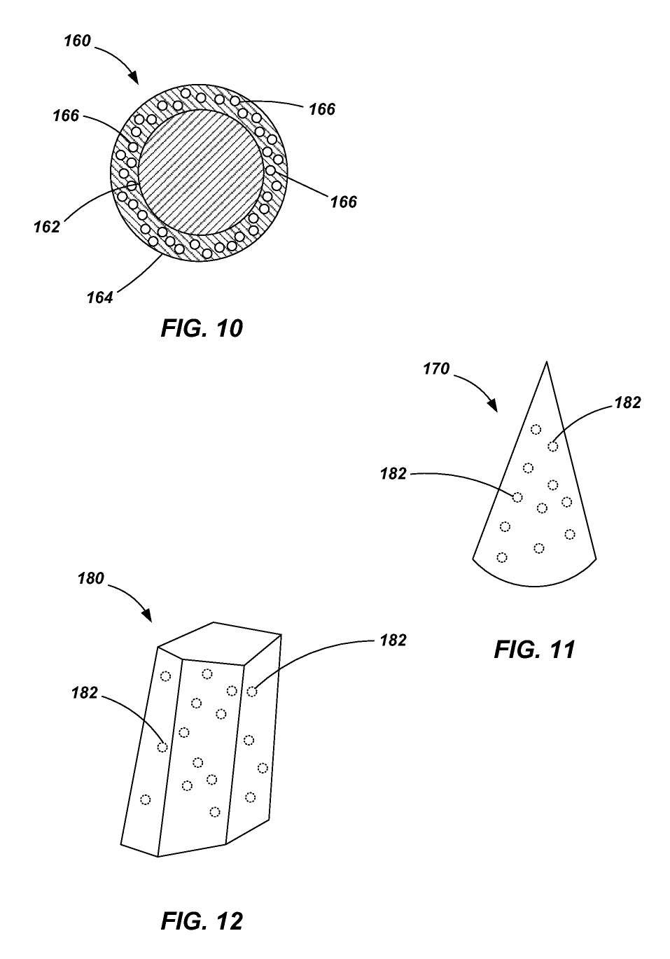

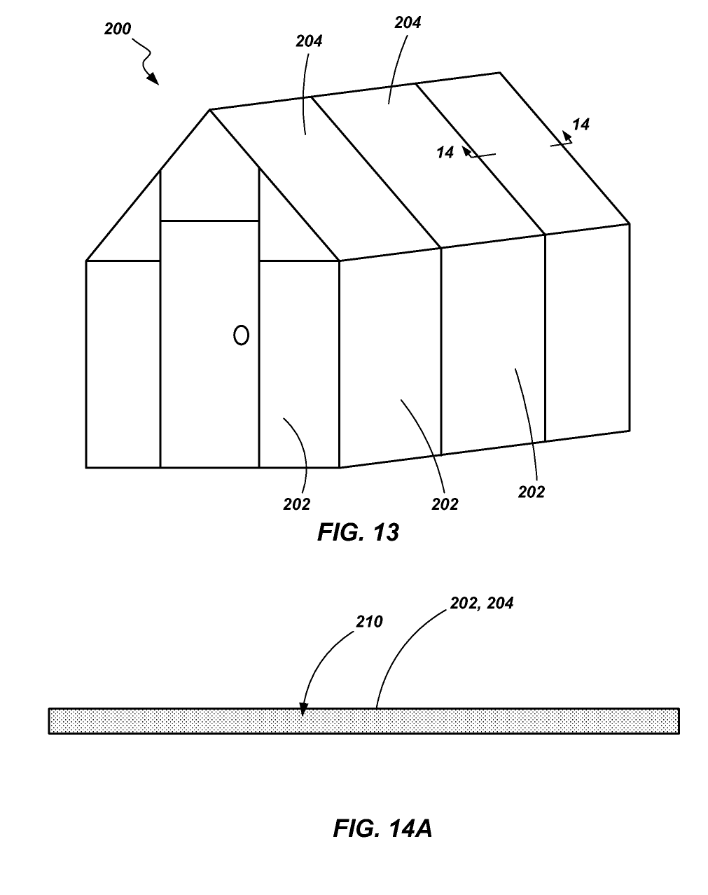

Referring to FIG. 13, a greenhouse structure 200 is shown. The greenhouse structure 200 may include a plurality of wall panels 202 and a plurality of ceiling panels 204. The wall panels 202, the ceiling panels 204, or both, may be configured to transmit and manipulate light such that light of a desired characteristic enters the greenhouse structure 200 in association with the photosynthesis process of plants contained within the greenhouse structure 200. The panels 202 and 204 may be formed, for example, of a glass or plastic material that is extruded or otherwise formed to a desired shape and size. In one embodiment, as shown in FIG. 14A, NPs 210 may be directly embedded into an extruded material (e.g., thermoplastic) used to form the panels 202 and 204. The NPs 210 may exhibit a desired density or concentration depending, for example, on the effect desired on light transmitted through the panel.

In another embodiment, such as shown in FIG. 14B, the panels 202 and 204 may be formed to include a plurality of channels or chambers 212. A fluid 214 may be disposed in the chambers 212, wherein the fluid acts as a carrier of the NPs 210. In one embodiment, the chambers 212 may be isolated from one another such that fluid contained in one chamber does not communicate with other chambers. In another embodiment, one or more of the chambers of a panel may be in communication with one another (and/or with chambers of other panels 202 and 204 of the greenhouse structure 200). In such an embodiment, the NP containing fluid 214 may be permitted to passively flow from one chamber 212 to another, or the fluid 214 may be actively pumped or flowed from one chamber 212 to another. In one embodiment, the distribution of the NPs within the fluid may be maintained through appropriate functionalization. For example, the NPs may exhibit a desired repulsive charge relative to each other (e.g., through a high Zeta charge) in order to maintain their spacing.

Referring to FIG. 14C, another embodiment of a panel 202 or 204 is shown wherein a coating or material layer 220 is disposed on one or more surfaces of a substrate 222 (e.g., of glass or plastic), wherein the material layer 220 includes a plurality of NPs 210 disposed therein. Such a coating or material layer 220 may be applied to the substrate 222, for example, by spraying (or otherwise applying) an NP solution over the substrate and allowing the solution to cure. In one embodiment, the NP-containing solution may include a mixture of glycerin and water, in which the NPs are dispersed. In another embodiment, the solution may include ethylene glycol. In certain embodiments, the solution may be selected based, at least in part, on its index of refraction when combined with the NPs dispersed therein.

In another embodiment, the material layer 220 may include a prefabricated film containing a plurality of NPs 210. The film (e.g., a polymer film) may be adhered to the substrate 222 by way of an appropriate adhesive material. In accordance with one embodiment of the invention, a solution containing NPs 210 or a film containing NPs 210 may be applied to an existing greenhouse structure in order to “retrofit” or upgrade the greenhouse to one where the spectral properties of light transmitted through the panels are manipulated in a desired manner.

In any of the embodiments shown in FIGS. 14A-14C, the NPs 210 associated with the panels 202 and 204 act to alter the light transmitted therethrough, providing a desired spectra for the plant life contained within the greenhouse structure 200.

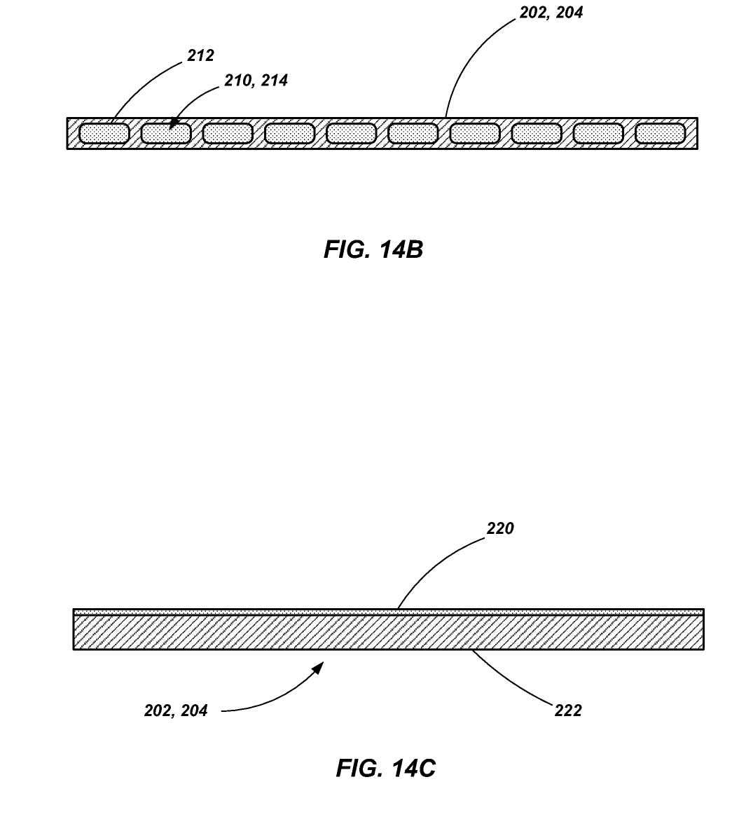

As shown in FIG. 15, NPs 210 may be embedded into a polymer film. For example, NPs 210 may be mixed with a polymer material 230 and undergo an extrusion process 232 to form the film 234. The film 234 may processed through a chiller 236 and collected on a roll 238 for subsequent distribution. The film 234 may then be used in a variety of ways including, as noted above, application to a new or existing greenhouse structure 200 for desired spectra modification or shifting.

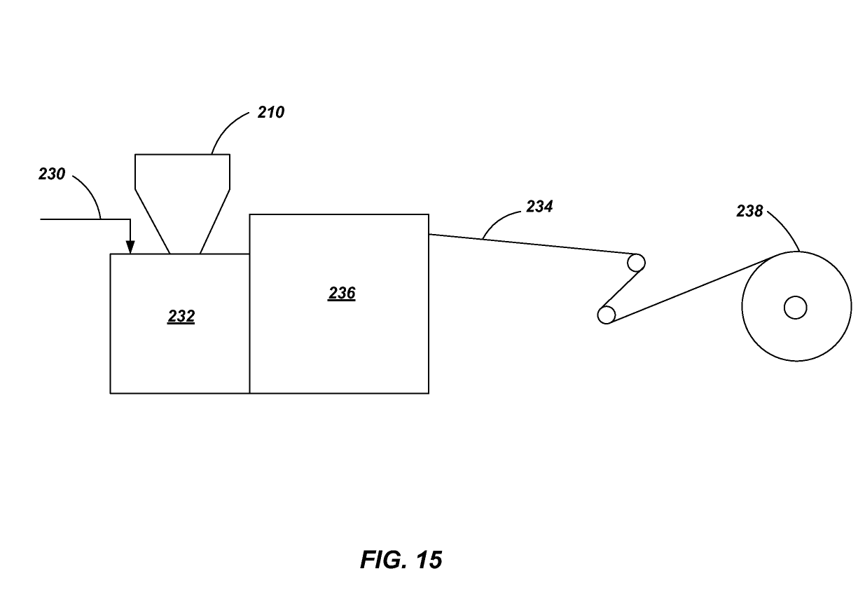

As shown in FIG. 16, NPs may be incorporated into retractable shades 240 (e.g., a sheet of polymer film containing NPs) that may be selectively deployed, for example, within a greenhouse structure 200 or some other environment. The retractable shades 240 may be deployed during specified times of the day, or during specified seasons, or in association with the growing of specified plant types, in order to provide an optimal spectra of light to the plant life being grown. In one embodiment, multiple shades 240 may be provided, each have a different manipulative effect on the spectra of light passing through the shades 240 and prior to reaching plant life. The various shades 240 may be deployed selectively either individually or in combination to produce a desired spectral shift or modification.

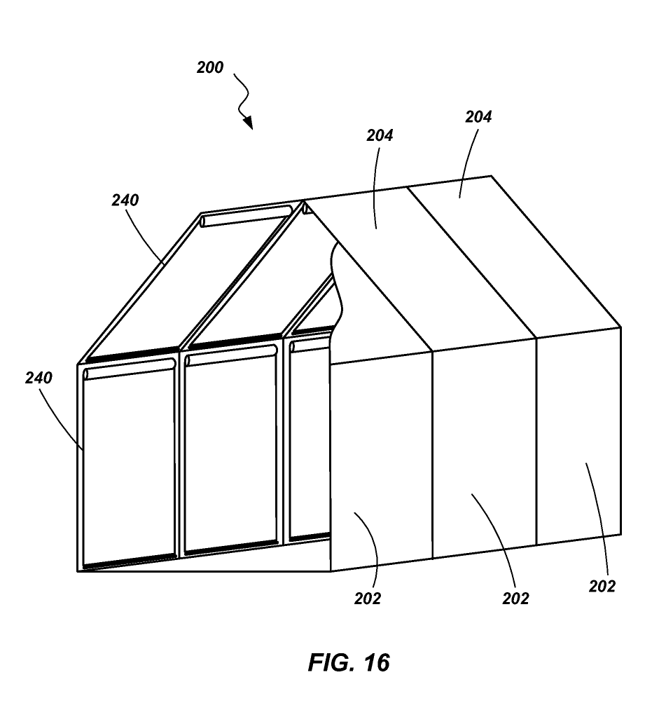

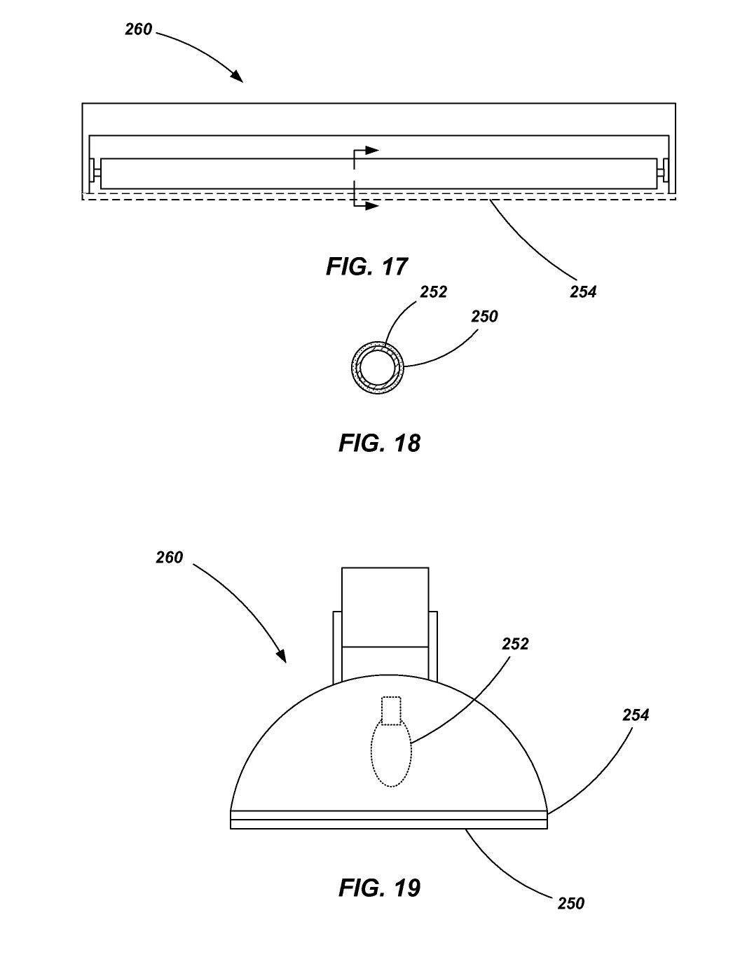

Referring to FIGS. 17-19, NP containing covers 250 may be employed with different types of electric lights. Such covers 250 may be formed from materials having the NPs embedded within (e.g., such as films, extruded plastics, etc.), or may be formed as a coating on a light bulb 252 or on an existing covering 254 for light fixture 260. Such covers 250 may be used in association with any type of light (e.g., incandescent, fluorescent, LED, etc.).

It is noted that the NP-containing layer described in the various embodiments (e.g., a panel 202, 204, a material layer 220, or a cover 250) may exhibit a thickness which is approximately twice as thick, or thicker, than the diameter (or largest cross-section dimension) of the largest NP contained within the material structure. Thus, for example, in one embodiment, the largest NP may exhibit a diameter (or maximum cross-sectional dimension) of approximately 75 nm to approximately 150 nm while the minimum thickness of the material structure (e.g., the panel 202, 204, material layer 220 or cover 250) may exhibit a minimum thickness of approximately 150 nm to approximately 300 nm or thicker. In other embodiments, the thickness of the coating may exhibit a different relationship to the size of the NPs.

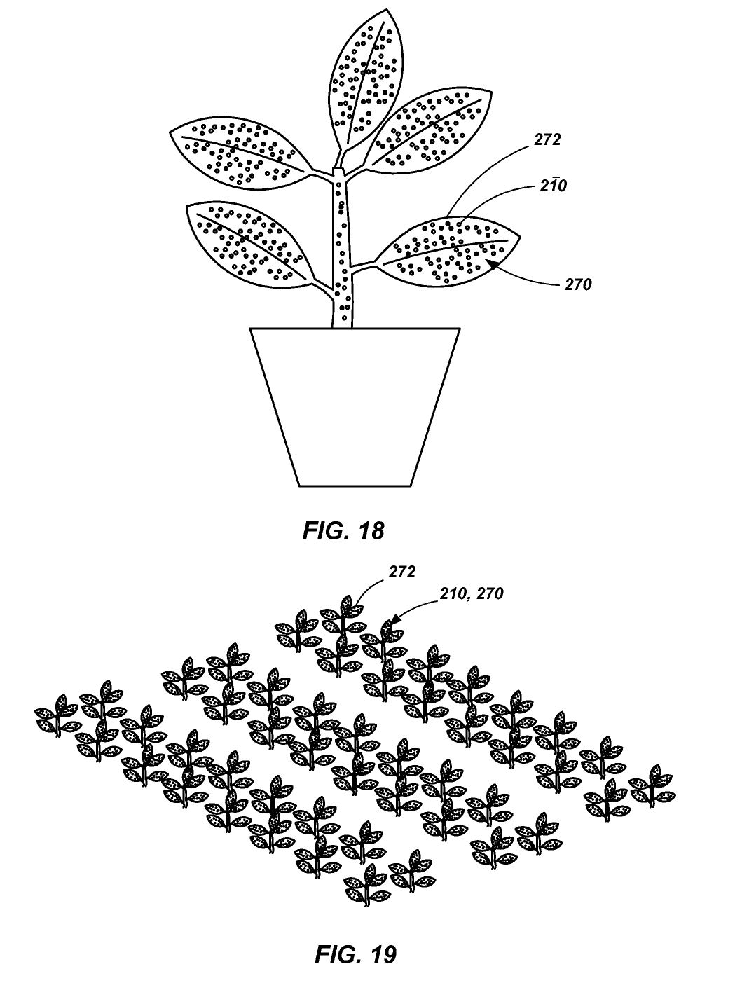

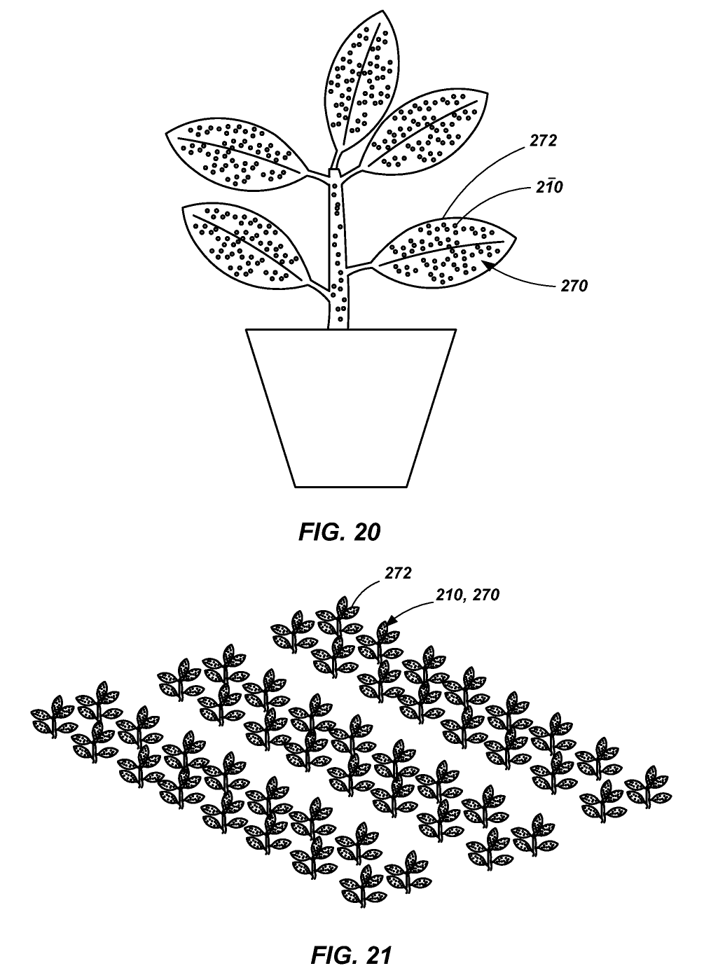

Referring to FIGS. 20 and 21, in accordance with another embodiment of the embodiment, an NP-containing material coating 270 may be applied directly to plant life. For example, the NP-containing coating 270 may be applied selectively to a single plant 272 (FIG. 19), or to several plants 272, such as in a crop field (FIG. 20), by dispersing NPs in a solution that includes a biologically inert material configured to adhere to the plant life and then spraying the solution on the plants. This may be done on a selective basis (i.e., individually, plant by plant), or it may be done on a larger scale (e.g., an entire field of crops, such as by “crop-dusting”). The applied coating, including NPs, shifts the spectra of light reaching the plant to a desired wavelength or range of wavelengths in order to enhance the growth of the plant (or inhibit the growth, in the case of an undesired plant life).

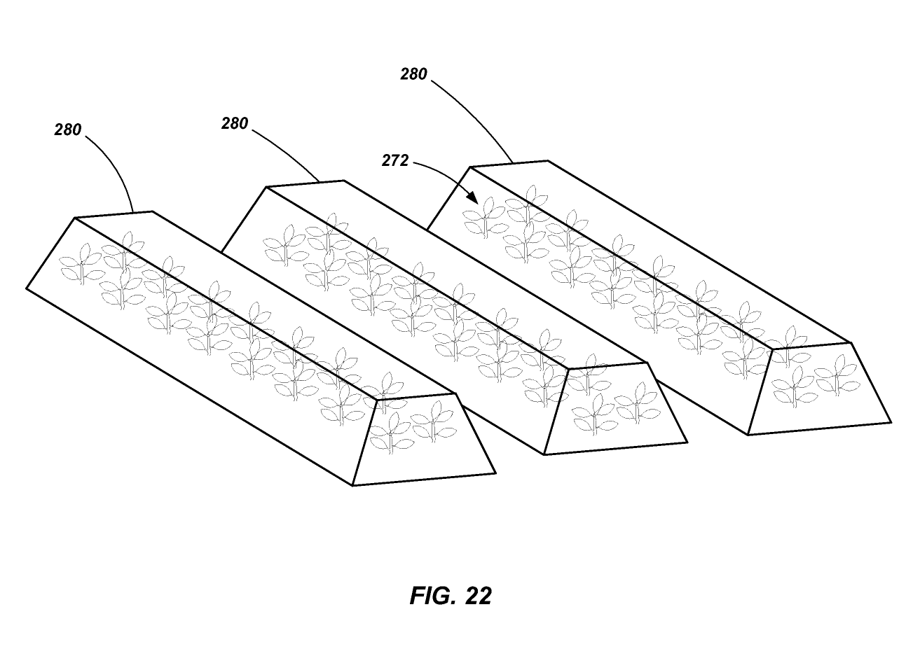

In another embodiment, such as shown in FIG. 22, portions of a crop field (e.g., one or more rows of plants) may be covered with a row tent 280 comprising NP-containing polymer film, NP-containing “bubble wrap” or similar transparent material. The NP-containing material may shift the wavelength of light prior to the light reaching the plants. Additionally, tent 270 may be configured to provide thermal insulation to protect the plants from unduly cold ambient temperatures or from other environmental threats. In one example, the tent structure 270 may be formed of panels (e.g., extruded thermoplastic panels). In another embodiment, the structure may be formed from a polymer film or bubble wrap material disposed over a framework that is positioned about the plants.

### EXAMPLE

The composite nanoparticle used in this experiment was prepared by NanoComposix of San Diego Calif. The nanoparticle was used to demonstrate energy shifting from one part of the spectrum to another. Specifications of the particle include:

| | |
|---|---|
| Silica core Diameter (TEM) | 119.2 nm |
| Gold shell thickness | 14.7 nm |
| Total diameter | 148.7 nm |

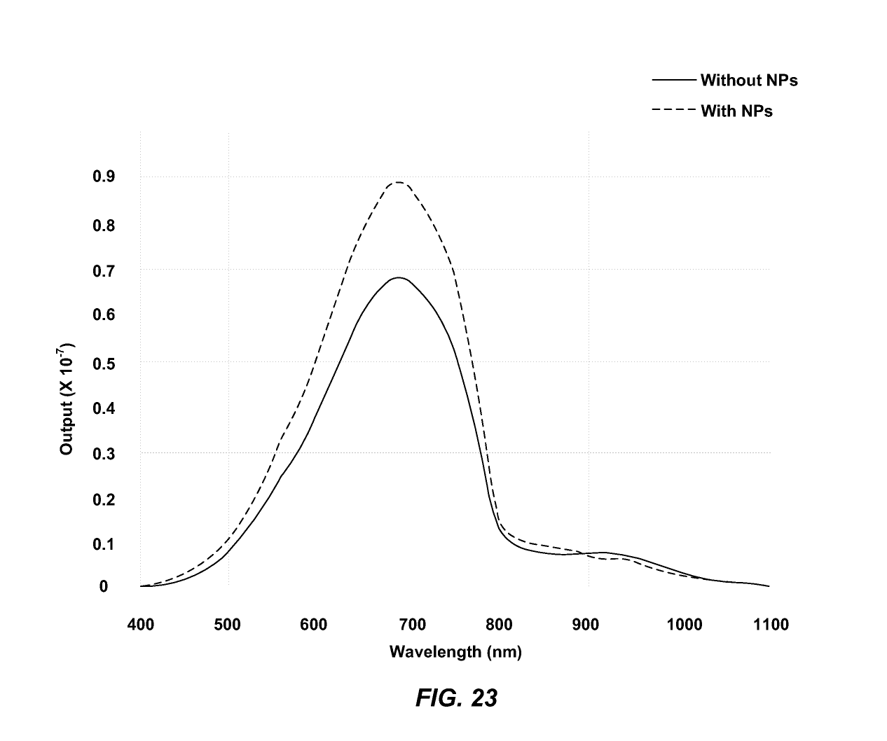

The NPs were dispersed within a solution of approximately 80% glycerin and approximately 20% water by volume. This provided a refractive index of approximately 1.4. A tungsten halide light was used having a wavelength spectrum that ranged from approximately 400 nm to approximately 1100 nm, with a peak of about 670 nm. A scanning wide spectrum spectrophotometer was used to analyze the light and linearization correction factors were used for the spectral sensitivity, by wavelength, as supplied by the manufacturer. The results of the analysis are shown in FIG. 22 which shows substantial enhancement of the light output, for the spectrum of light analyzed (as expressed on the x-axis) when passed through the solution containing NPs. The y-axis of the graph shown in FIG. 23 represents a relative scale of luminosity for a given wavelength and is expressed in nanowatts.

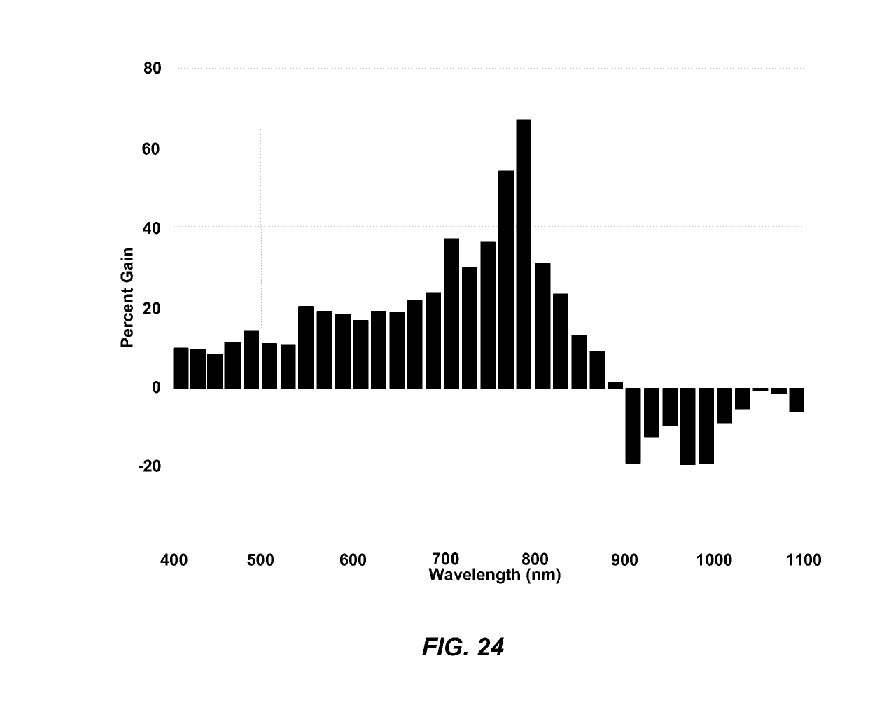

FIG. 24 shows the results of the experiment in terms of relative percentages of gain or loss in luminosity (on the y-axis) for a given wavelength (the x-axis) as compared to light not modified by the NP solution described above.

As seen in FIGS. 23 and 24, as wide-spectrum white light is passed through a semi-micro cuvette in the experiment, the NPs interacted with the light, attenuating the energy in some areas of the spectrum, while increasing the energy at other areas of the spectrum.

It is noted that the 650 nm-700 nm spectral region, which corresponds to the sensitivity of chlorophyll type-A receives a significant boost in energy. Thus, NPs can be engineered to accommodate spectral shifts to alter many aspects of the plant lifecycle and energy capture by chlorophyll.

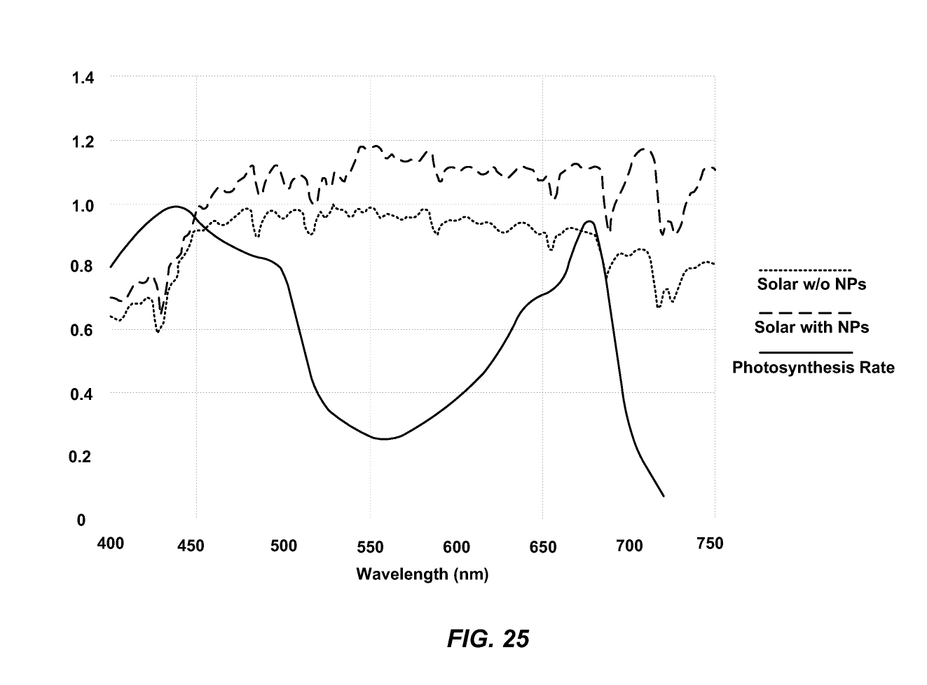

FIG. 25 shows the photo sensitivity of plant life with a peak sensitivity in the 650 nm and 700 nm, an overlays this data with graphs showing the solar spectrum without any enhancement (i.e., without the use of NPs) and also with enhancement (i.e., by way of a solution containing NPs), based on the experimental data obtained above, FIG. 25 shows that the sunlight will be enhanced at the peak sensitivity of the plants in the 650 nm-700 nm region. Again, the y-axis in FIG. 25 represents a relative scale of luminosity with the x-axis representing the wavelength.

It is noted that the NPs can be altered in size, quantity, material, etc. in order to fine-tune the enhancement of available light and provide larger gains in specifically identified areas of the spectrum depending on the intended purpose and anticipated response of a given plant.

Thus, the NPs enable the transforming of energy from wavelengths such as infrared, which are not useful to a plant, to useful wavelengths (or vice versa, depending on the desired effect to the plant life). The wavelength shifts are also dependent upon the index of refraction of the material in which the NPs are dispersed. The Index of refraction may be varied, for example, by creating different mixtures of glycerin and water, or by providing other solutions or materials in which to disperse the NPs. The behavior of the wavelength shift in a solid material may be predicted by emulating its known index of refraction. When using a composite NP, such as described above, of sufficient size, it is believed that a single particle may act on the surrounding light and not require vast number of the NPs to form a plasmon.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A method of altering plant growth, the method comprising:
disposing a plurality of nanoparticles (NPs) between a light source and a plant component;
interacting light from the light source with the plurality of NPs and altering a characteristic of the light; and
transmitting the altered light to the plant.

2. The method according to claim 1, wherein altering a characteristic of the light includes shifting the light from a first wavelength to a second wavelength.

3. The method according to claim 1, wherein disposing a plurality of NPs between a light source and a plant component further comprises applying the NPs to a surface of the plant component.

4. The method according to claim 3, wherein applying the NPs to a surface of the plant component includes dispersing the NPs in a liquid solution and applying the liquid solution on the plant component.

5. The method according to claim 1, further comprising applying the NPs to a surface of a structure associated with the light source.

6. The method according to claim 1, wherein disposing a plurality of NPs between a light source and a plant component further comprises embedding the NPs in a plastic or glass material and disposing the plastic or glass material between the light source and the plant component.

7. The method according to claim 1, wherein disposing a plurality of NPs between a light source and a plant component further comprises embedding the NPs in a polymer film and disposing the polymer film between the light source and the plant component.

8. The method according to claim 1, wherein disposing a plurality of NPs between a light source and a plant component further comprises disposing the NPs on a surface of a substantially transparent or translucent structure.

9. The method according to claim 1, wherein disposing a plurality of NPs between a light source and a plant component includes forming a greenhouse structure, the greenhouse structure comprising the plurality of NPs.

10. The method according to claim 1, wherein the NPs are disposed within a material and wherein the thickness of the material is approximately twice the diameter of the largest NPs disposed within the material or greater.

11. The method according to claim 9, wherein the minimum thickness of the material is between about 150 nm and about 300 nm.

12. The method according to claim 1, wherein the plant component includes a seed, and wherein the method further comprises altering the germination time of the plant seed responsive to the altered light.

13. The method according to claim 1, further comprising altering the bloom time of the plant component responsive to the altered light.

14. The method according to claim 1, further comprising disposing the NPs in a liquid solution.

15. The method of claim 1, wherein the plurality of NPs includes at least two differently sized NPs.

16. The method according to claim 1, wherein the plurality of NPs includes at least two differently shaped NPs.

17. The method according to claim 1, further comprising suspending the plurality of NPs in a biologically inert, optically clear adhesive material.

18. The method according to claim 17, further comprising applying the adhesive material directly to the plant component.

19. The method according to claim 1, wherein the plant component includes algae.

20. The method according to claim 1, further comprising subsequently forming a synthetic fuel from the plant component.

21. The method according to claim 1, wherein shifting the wavelength of light transmitted from the light source through the NPs includes shifting the light to a wavelength to inhibit plant growth.

22. A structure configured to alter plant growth comprising:
at least one substantially optically transparent component;
a plurality of nanoparticles (NPs) associated with the at least one component, the plurality of NPs being configured to alter a light wave from a first wavelength to a second wavelength in order to alter the growth cycle of a plant.

23. The structure of claim 22, wherein the at least one component includes a panel in a greenhouse structure.

24. The structure of claim 22, wherein the at least one component includes a retractable light shade.

25. The structure of claim 22, wherein the at least one component is configured to cover at least a portion of a row of plants in a crop field.

26. The structure of claim 22, wherein the plurality of NPs are embedded in the at least one component.

27. The structure of claim 22, wherein the plurality of NPs are coated on a surface of the at least one component.

28. The structure of claim 22, wherein the plurality of NPs include at least two differently sized NPs.

29. The structure of claim 22, wherein the plurality of NPs include at least two differently shaped NPs.
